(19) United States
(12) Patent Application Publication
(10) Pub. No.: US 2007/0109945 A1
(43) Pub. Date: May 17, 2007

(54) Optical pickup

(75) Inventors: Yuichi Kamioka, Osaka (JP); Kenji Nagashima, Osaka (JP); Kazuhiro Takahashi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/598,722

(22) Filed: Nov. 14, 2006

(30) Foreign Application Priority Data
Nov. 15, 2005 (JP) 2005-329701

(51) Int. Cl. G11B 7/00

(52) U.S. Cl. 369/112.02; 369/112.05

(57) ABSTRACT

An optical pickup includes a laser diode for BD, a laser diode for DVD and CD, a collimator lens, an objective lens for BD. A blue color laser beam emitted from the laser diode for BD passes through the collimator lens to become parallel rays, which enter the objective lens for BD. Other red color laser beam and infrared laser beam emitted from the laser diode for DVD and CD pass through the collimator lens to become diverging non-parallel rays, which enter the objective lens for BD. In this way, optical components are arranged.

This application is based on Japanese Patent Application No. 2005-329701 filed on Nov. 15, 2005, the contents of which are hereby incorporated by reference.

### BACKGROUND OF THE INVENTION

1. Field of the Invention

The present invention relates to an optical pickup that supports a plurality of disk types.

2. Description of Related Art

A conventional example of an optical pickup that is capable of recording and reading information on a plurality of types of optical disks having different recording densities is disclosed in JP-A-2005-166173.

Recently, a Blu-ray Disc (hereinafter referred to as a BD) has become available as a disk having recording capacity higher than a DVD. The BD realizes high density by using a blue color laser beam having a wavelength of 405 nm and an objective lens having a numerical aperture of 0.85 for minimizing a diameter of a laser spot on the disk. Furthermore, the numerical aperture for the BD is larger than that for the DVD (numerical aperture=0.6), and a comatic aberration due to a tilt of the disk becomes large in the BD. Therefore, a thickness of a cover layer of the BD is designed to be 0.1 mm that is ⅙ of a cover layer of the DVD.

A device for recording and reading information on the BD is equipped with an optical pickup that supports both the BD and the DVD for maintaining compatibility with the conventional DVD. One of such optical pickups that have developed is equipped with an objective lens for the BD and an objective lens for the DVD. When information is recorded on or read from the BD, a blue color laser beam (having a wavelength of 405 nm) is emitted from a blue color laser diode and is condensed on the disk by the objective lens having a numerical aperture of 0.85. When information is recorded on or read from the DVD, a red color laser beam (having a wavelength of 650 nm) is emitted from a red color laser diode and is condensed on the disk by the objective lens having a numerical aperture of 0.6.

The optical pickup described above can support both the BD and the DVD, but it needs two objective lenses and a switching mechanism of them. Therefore, the number of components increases, and it is difficult to avoid an increase of cost.

### SUMMARY OF THE INVENTION

An object of the present invention is to provide an optical pickup that can support a plurality of types of disks at a low cost.

An optical pickup according to an aspect of the present invention includes a first light source for a first disk, a second light source for a second disk that has a lower density than the first disk, a collimator lens, and an objective lens for the first disk. An optical axis of a first light beam emitted from the first light source overlaps an optical axis of the collimator lens, and a length of the optical axis of the first light beam from the first light source to a principal plane of the collimator lens is the same as a focal length of the collimator lens at a wavelength of the first light beam, so that the first light beam going out from the collimator lens and entering the objective lens for the first disk becomes parallel rays. In addition, an optical axis of a second light beam emitted from the second light source overlaps an optical axis of the collimator lens, and a length of the optical axis of the second light beam from the second light source to the principal plane of the collimator lens is shorter than the focal length of the collimator lens at the wavelength of the second light beam, so that the second light beam going out from the collimator lens and entering the objective lens for the first disk becomes non-parallel rays.

According to this structure, one objective lens enables recording and reproducing information on two types of disks with reducing spherical aberration, so that a cost of the optical pickup can be reduced.

According to a preferred embodiment of the present invention, a degree of non-parallelization of the second light beam entering the objective lens for the first disk is adjusted so that a comatic aberration generated on a recording surface of the second disk becomes a value within a tolerance when the objective lens for the first disk is shifted at most in the tracking direction. Thus, the spherical aberration and the comatic aberration generated on the second disk can be reduced so that a reproduction error or a recording failure can be prevented.

In another preferred embodiment of the present invention, the optical pickup further includes a liquid crystal element for correcting a spherical aberration that is generated on the recording surface of the second disk. Thus, the spherical aberration, which is generated on the second disk and remains as the comatic aberration is reduced as described above, can be corrected.

In still another preferred embodiment of the present invention, the optical pickup further includes a monolithic laser diode chip having the second light source and a third light source for a third disk that has lower density than the first disk, and a hologram element disposed on an optical path from the monolithic laser diode chip to the collimator lens. In addition, a third light beam emitted from the third light source enters the hologram element, an optical axis of the third light beam going out from the hologram element overlaps the optical axis of the second light beam, and a length of the optical axis of the third light beam from the third light source to the principal plane of the collimator lens is shorter than a length of an optical axis from the position where light going out from the hologram element is focused to the principal plane of the collimator lens when parallel rays having the same wavelength as the third light beam enter the collimator lens, so that the third light beam going out from the collimator lens and entering the objective lens for the first disk becomes the non-parallel rays.

According to this structure, even if one monolithic laser diode chip is used for supporting three types of disks, one objective lens is sufficient for realizing recording and reproducing information while reducing the spherical aberration.

In still another preferred embodiment of the present invention, a degree of non-parallelization of the third light beam entering the objective lens for the first disk is adjusted so that a comatic aberration that is generated on a recording surface of the third disk becomes a value within a tolerance when the objective lens for the first disk is shifted at most in the tracking direction. Thus, the spherical aberration and the comatic aberration generated on the third disk can be reduced so that a reproduction error or a recording failure can be prevented.

In still another preferred embodiment of the present invention, the optical pickup further includes a liquid crystal element for correcting a spherical aberration that is generated on the recording surface of the third disk. Thus, the spherical aberration, which is generated on the third disk and remains as the comatic aberration is reduced as described above, can be corrected.

Note that the first disk is a BD, the second disk is a DVD, and the third disk is a CD, for example.

According to the present invention, the optical pickup that supports a plurality of types of disks can be provided at a low cost.

### BRIEF DESCRIPTION OF THE DRAWINGS

FIG. 1 shows a general structure of an optical pickup that supports recording and reproducing information on BD, DVD and CD according to an embodiment of the present invention.

FIG. 2 shows an optical system from a laser diode for DVD and CD to a collimator lens.

FIG. 3A shows an optical system from a light emission point for DVD of a monolithic laser diode chip to an objective lens for BD.

FIG. 3B shows an optical system for a simulation of a comatic aberration.

FIG. 4 is a graph showing a simulation result of the comatic aberration that is generated on the DVD when the objective lens for BD is shifted at most.

FIG. 5 is a graph showing an example of a relationship between the comatic aberration generated on a recording surface of the DVD and a jitter of a reproduction signal measured at that time.

FIG. 6 shows an optical system from a light emission point for CD of the monolithic laser diode chip to the objective lens for BD.

FIG. 7 is a graph showing a simulation result of the comatic aberration that is generated on the CD when the objective lens for BD is shifted at most.

FIG. 8 is a graph showing an example of a relationship between the comatic aberration generated on a recording surface of the CD and a jitter of a reproduction signal measured at that time.

### DESCRIPTION OF THE PREFERRED EMBODIMENTS

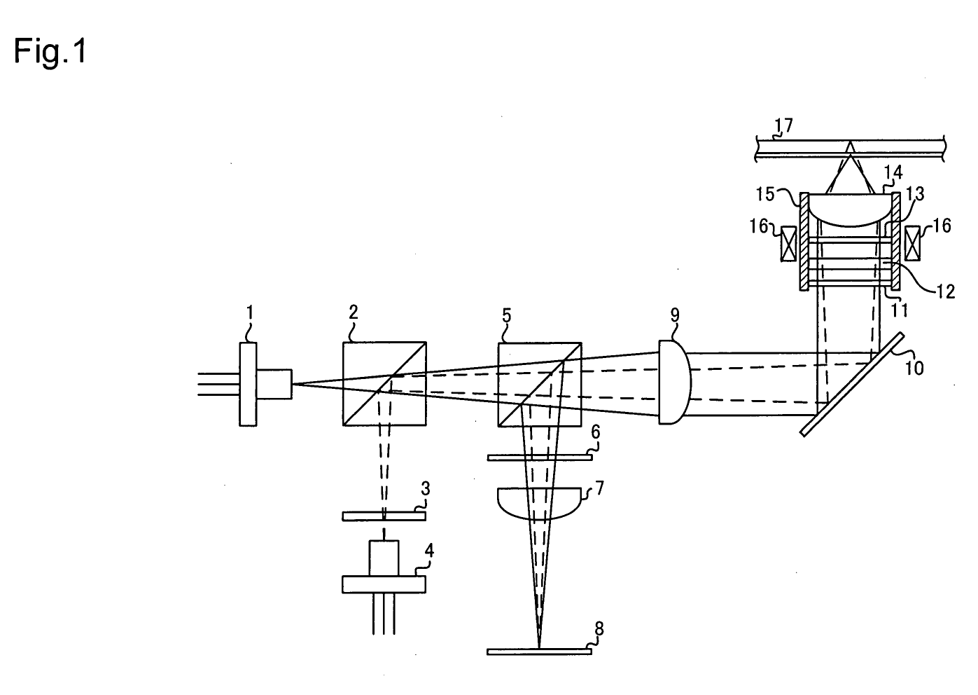

Now, an embodiment of the present invention will be described with reference to the attached drawings. FIG. 1 shows a general structure of an optical pickup that supports recording and reproducing information on BD, DVD and CD according to an embodiment of the present invention.

This optical pickup includes a laser diode 1 for BD, a dichroic prism 2, a hologram element 3, laser diode 4 for DVD and CD, a polarizing beam splitter 5, a wavelength selective focal position variable element 6, a cylindrical lens 7, a photo detector 8, a collimator lens 9, a mirror 10, a wavelength selective aperture 11, a liquid crystal element 12, a quarter wave length plate 13, an objective lens 14 for BD, a lens holder 15 and an actuator 16.

First, when information is reproduced or recorded on the BD, the laser diode 1 for BD emits a blue color laser beam having a wavelength of 405 nm. The blue color laser beam emitted from the laser diode 1 for BD passes through the dichroic prism 2 and the polarizing beam splitter 5 in turn and enters the collimator lens 9.

Here, the blue color laser beam is emitted from a light emission point of a laser diode chip included in the laser diode 1 for BD, and an optical axis of the blue color laser beam is adjusted to overlap an optical axis of the collimator lens 9. Furthermore, a length of the optical axis of the blue color laser beam from the light emission point to a principal plane of the collimator lens 9 is adjusted to be the same as a focal length of the collimator lens 9 at the wavelength of the blue color laser beam. Therefore, the blue color laser beam that enters the collimator lens 9 becomes parallel rays and goes out from the collimator lens 9.

The blue color laser beam that is parallel rays going out from the collimator lens 9 is reflected by the mirror 10 and enters the wavelength selective aperture 11. The wavelength selective aperture 11 restricts its aperture in accordance with a wavelength and permits the blue color laser beam to pass through. The blue color laser beam that passed the wavelength selective aperture 11 enters the liquid crystal element 12. The liquid crystal element 12 changes a wavefront of the passing laser beam in accordance with a voltage supplied from a liquid crystal driver (not shown). Here, the liquid crystal element 12 is not supplied with a voltage, so the wavefront of the passing blue color laser beam is not changed. The blue color laser beam that passed the liquid crystal element 12 further passes the quarter wave length plate 13 and enters the objective lens 14 for BD as parallel rays. Then, the blue color laser beam is condensed by the objective lens 14 for BD with a numerical aperture of 0.85 on the recording surface of a disk 17 after passing through a cover layer (having a thickness of 0.1 mm).

The blue color laser beam reflected by the recording layer of the disk 17 passes through the objective lens 14 for BD, the quarter wave length plate 13, the liquid crystal element 12 and the wavelength selective aperture 11 in turn. Then, the blue color laser beam is reflected by the mirror 10, passes the collimator lens 9, and enters the polarizing beam splitter 5. Since this blue color laser beam has passed through the quarter wave length plate 13 twice (in two ways), it is reflected by the polarizing beam splitter 5 so that its optical path is bent and enters the wavelength selective focal position variable element 6. The wavelength selective focal position variable element 6 adjusts a focal position of a laser beam that passes through the element in accordance with its wavelength, but it permits the blue color laser beam to pass through. The blue color laser beam that passed through the wavelength selective focal position variable element 6 is given astigmatism by the cylindrical lens 7 and is condensed on the reception surface of the photo detector 8.

A reproduction signal, a focus error signal and a tracking error signal are generated from an output signal of the photo detector 8. Then, the actuator 16 drives the lens holder 15 that holds the objective lens 14 for BD, the quarter wave length plate 13, the liquid crystal element 12 and the wavelength selective aperture 11 based on the focus error signal and the tracking error signal. More specifically, it drives the lens holder 15 in a focus direction (that is perpendicular to a disk surface) for realizing a focus servo, and it drives the lens holder 15 in tracking direction (in the radial direction of the disk) for realizing a tracking servo.

Next, when information is reproduced and recorded on the DVD, the laser diode 4 for DVD and CD emits a red color laser beam having a wavelength of 650 nm. The red color laser beam emitted from the laser diode 4 for DVD and CD passes through the hologram element 3 and is reflected by the dichroic prism 2 so that its optical path is bent. Then, the red color laser beam passes through the polarizing beam splitter 5 and enters the collimator lens 9.

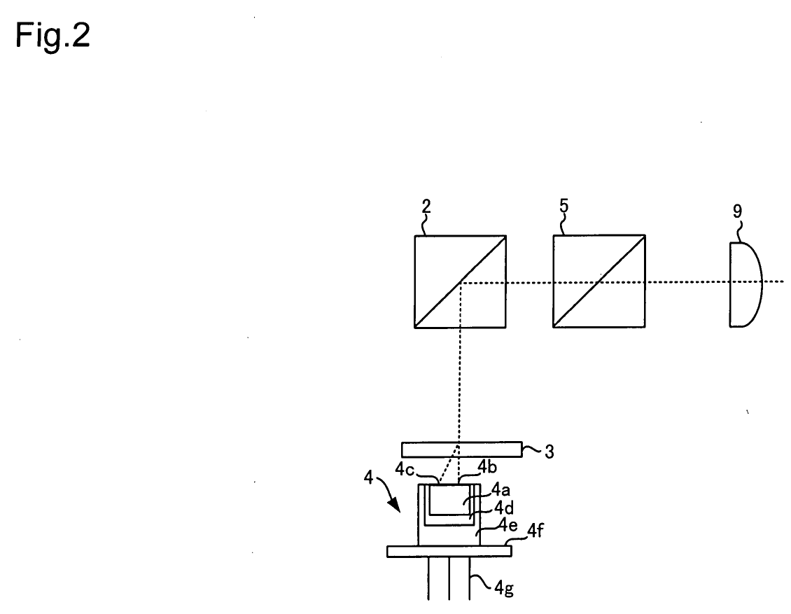

FIG. 2 shows an optical system from a laser diode 4 for DVD and CD to a collimator lens 9. The laser diode 4 for DVD and CD includes a monolithic laser diode chip 4a, a sub mount 4d, a pedestal 4e, a stem 4f and terminal pins 4g. The pedestal 4e is disposed on the stem 4f having a disk-like shape, the sub mount 4d is disposed on the pedestal 4e, and the monolithic laser diode chip 4a is disposed on the sub mount 4d. In addition, a plurality of terminal pins 4g penetrate the stem 4f and are connected to the monolithic laser diode chip 4a with lead wires (not shown). The monolithic laser diode chip 4a is made up of a single chip that supports two wavelengths, and it includes a light emission point 4b for DVD and a light emission point 4c for CD. When it is supplied with driving current via the terminal pins 4g, the red color laser beam (having a wavelength of 650 nm) is emitted from the light emission point 4b for DVD, or an infrared laser beam (having a wavelength of 780 nm) is emitted from the light emission point 4c for CD. As shown in FIG. 2, an optical axis of the red color laser beam emitted from the light emission point 4b for DVD is adjusted to overlap an optical axis of the collimator lens 9. Then, the red color laser beam entering the collimator lens 9 goes out from the collimator lens 9 as diverging non-parallel rays as described later.

With reference to FIG. 1 again, the red color laser beam that is the non-parallel rays going out from the collimator lens 9 is reflected by the mirror 10 and enters the wavelength selective aperture 11. The red color laser beam enters the liquid crystal element 12 after its numerical aperture is restricted to 0.6 by the wavelength selective aperture 11. The liquid crystal element 12 is supplied with a voltage from the liquid crystal driver (not shown) and changes a wavefront of the passing red color laser beam. Thus, a spherical aberration that is generated on the recording surface of the disk 17 can be corrected.

Then, the red color laser beam passes through the quarter wave length plate 13 and enters the objective lens 14 for BD as the non-parallel rays. After that, the red color laser beam is condensed on the recording surface of the disk 17 by the objective lens 14 for BD with a numerical aperture 0.6 after passing through a cover layer (having a thickness of 0.6 mm).

The red color laser beam reflected by the recording layer of the disk 17 passes through the objective lens 14 for BD, the quarter wave length plate 13, the liquid crystal element 12 and the wavelength selective aperture 11 in turn. Then, the red color laser beam is reflected by the mirror 10, passes the collimator lens 9, and enters the polarizing beam splitter 5. Since the red color laser beam has passed the quarter wave length plate 13 twice (in two ways), it is reflected by the polarizing beam splitter 5 so that its optical path is bent and enters the wavelength selective focal position variable element 6. After a focal position of the red color laser beam is adjusted by the wavelength selective focal position variable element 6, the red color laser beam is given astigmatism by the cylindrical lens 7 and is condensed on the reception surface of the photo detector 8.

In the same way as the above-mentioned case of the BD, the reproduction signal, the focus error signal and the tracking error signal are generated from the output signal of the photo detector 8, so that the focus servo and the tracking servo are performed.

Next, when information is reproduced and recorded on the CD, the laser diode 4 for DVD and CD emits a infrared laser beam having a wavelength of wavelength 780 nm. As shown in FIG. 2, an optical axis of the infrared laser beam that is emitted from the light emission point 4c for CD and enters the hologram element 3 is inclined with respect to the hologram element 3, and an optical axis of the infrared laser beam emitted from the hologram element 3 is deflected by the hologram element 3 so as to overlap the optical axis of the red color laser beam emitted from the light emission point 4b for DVD. The infrared laser beam emitted from the hologram element 3 is reflected by the dichroic prism 2 so that its optical path is bent. Then, the infrared laser beam passes through the polarizing beam splitter 5 and enters the collimator lens 9. The infrared laser beam that enters the collimator lens 9 becomes diverging non-parallel rays and goes out from the collimator lens 9.

In FIG. 1, the infrared laser beam that is the non-parallel rays emerged from the collimator lens 9 is reflected by the mirror 10 and enters the wavelength selective aperture 11. The wavelength selective aperture 11 restricts a numerical aperture of the infrared laser beam to 0.45, and the infrared laser beam enters the liquid crystal element 12. The liquid crystal element 12 is supplied with a voltage from the liquid crystal driver (not shown) so as to change a wavefront of the passing infrared laser beam. Thus, a spherical aberration that is generated on the recording surface of the disk 17 can be corrected.

Then, the infrared laser beam passes the quarter wave length plate 13 and enters the objective lens 14 for BD as non-parallel rays. Then the infrared laser beam is condensed by the objective lens 14 for BD with a numerical aperture of 0.45 on the recording surface of the disk 17 after passing through its cover layer (having a thickness of 1.2 mm).

The infrared laser beam that is reflected by the recording layer of the disk 17 passes through the objective lens 14 for BD, the quarter wave length plate 13, the liquid crystal element 12 and the wavelength selective aperture 11 in turn. Then, the infrared laser beam is reflected by the mirror 10, passes through the collimator lens 9, and enters the polarizing beam splitter 5. Since the infrared laser beam has passed through the quarter wave length plate 13 twice (in two ways), it is reflected by the polarizing beam splitter 5 so that its optical path is bent and enters the wavelength selective focal position variable element 6. Then, a focal position of the infrared laser beam is adjustment by the wavelength selective focal position variable element 6, and the infrared laser beam is condensed on the reception surface of the photo detector 8 after given astigmatism by the cylindrical lens 7.

In the same way as the above-mentioned case of the BD, the reproduction signal, the focus error signal and the tracking error signal are generated from the output signal of the photo detector 8, so that the focus servo and the tracking servo are performed.

As described above, when information is reproduced or recorded on the DVD, the red color laser beam that enters the objective lens 14 for BD is the diverging non-parallel rays. If the red color laser beam enters the objective lens 14 for BD as parallel rays, a spherical aberration will be generated on the disk recording surface of the DVD due to a difference between wavelengths of the red color laser beam and the blue color laser beam for BD or a difference between the thicknesses of the cover layers of the DVD disk and the BD disk. In order to reduce the spherical aberration, the red color laser beam that enters the objective lens 14 for BD is adjusted to become diverging non-parallel rays.

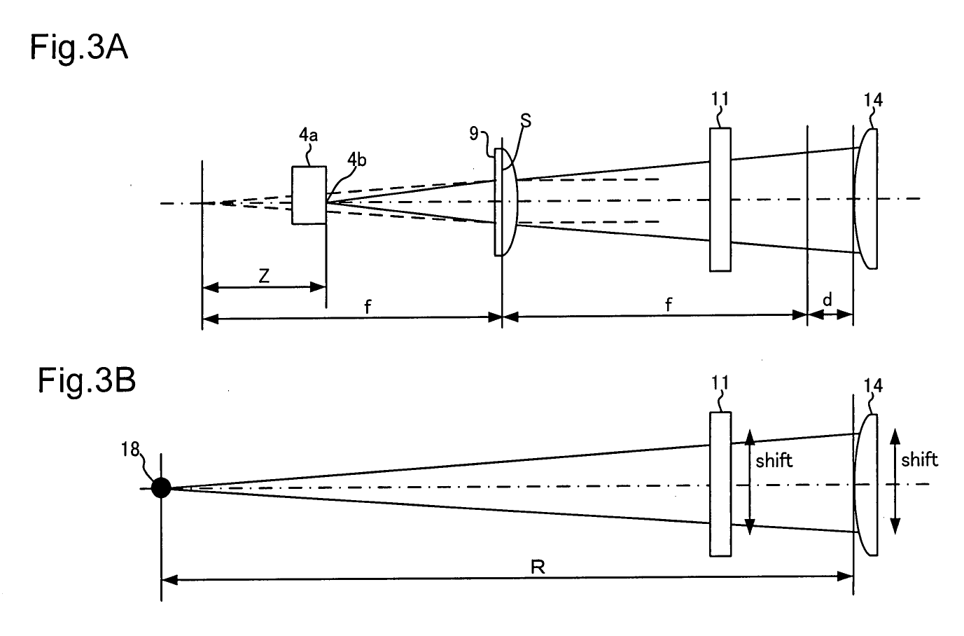

FIG. 3A shows an optical system from a light emission point 4b for DVD of the monolithic laser diode chip 4a to the objective lens 14 for BD. However, optical components other than the monolithic laser diode chip 4a, the collimator lens 9, the wavelength selective aperture 11 and the objective lens 14 for BD are omitted. As shown in FIG. 3A, the monolithic laser diode chip 4a and the collimator lens 9 are arranged so that a length of the optical axis of the red color laser beam from the light emission point 4b for DVD to a principal plane S of the collimator lens 9 becomes smaller than a focal length f of the collimator lens 9 at the wavelength of the red color laser beam. Thus, the red color laser beam that goes out from (passes through) the collimator lens 9 becomes the diverging non-parallel rays, and the red color laser beam that enters the objective lens 14 for BD becomes the diverging non-parallel rays.

If a degree of non-parallelization of the red color laser beam that enters the objective lens 14 for BD is set to be a large value, the spherical aberration can be zero substantially. However, if the degree of non-parallelization is set to be an excessively large value, a comatic aberration, which is generated on the recording surface of the disk when the objective lens 14 for BD is shifted in the tracking direction by the tracking servo, increases and exceeds a permissible value. If the comatic aberration exceeds the permissible value, a reproduction error or a recording failure may be generated due to a cross talk. In order to avoid this situation, the following countermeasure is adopted in the present invention.

As shown in FIG. 3B, it is supposed that a red light source 18 is disposed at a position away from the surface of the objective lens 14 for BD by a distance R, the objective lens 14 for BD is shifted in the tracking direction so that the optical axis of the objective lens 14 for BD is shifted from the optical axis of the red light emitted from the red light source 18, and the wavelength selective aperture 11 disposed between the red light source 18 and the objective lens 14 for BD is also shifted together with the objective lens 14 for BD as one unit. Since the objective lens 14 for BD and the wavelength selective aperture 11 are mounted on the same lens holder 15 as described above, they can be shifted as one unit actually. Under this situation, a simulation of the comatic aberration that is generated on the recording surface of the disk was performed.

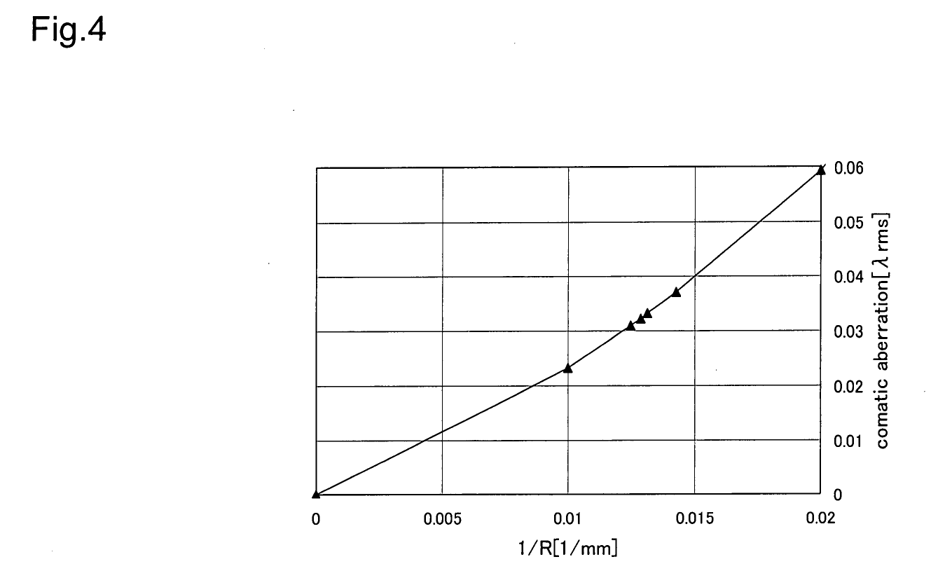

FIG. 4 shows a simulation result of the comatic aberration that is generated when the objective lens 14 for BD is shifted at most in the tracking direction while changing the distance R. In a graph of FIG. 4, the horizontal axis is 1/R. When 1/R is zero, i.e., R is infinite, light entering the objective lens 14 for BD becomes parallel rays, and the comatic aberration is not generated (becomes zero). The more the 1/R increases from zero, the degree of non-parallelization of the light entering the objective lens 14 for BD increases, resulting in an increase of the comatic aberration.

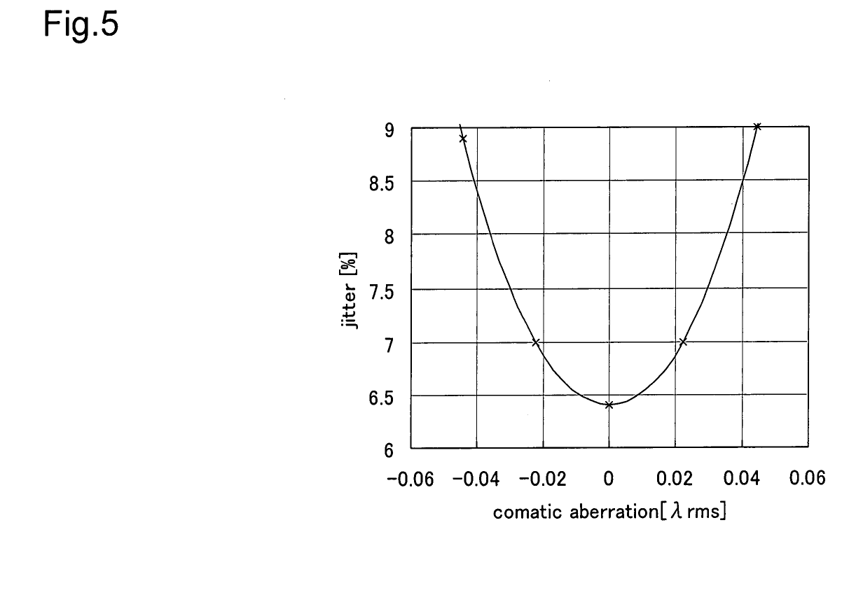

FIG. 5 shows an example of a relationship between the comatic aberration generated on the recording surface of the DVD and a jitter of a reproduction signal measured at that time. In this example, the jitter becomes the minimum value 6.4% when the comatic aberration is zero. If the permissible value (the maximum value) of the jitter is 7.4% that is 1% larger than the minimum value 6.4%, the tolerance of the comatic aberration becomes −0.028 to 0.028 (λrms) as shown in FIG. 5. Since the comatic aberration becomes 0.028 (λrms) when 1/R is 0.012 (1/mm) in FIG. 4, the comatic aberration is still within the tolerance even if the objective lens 14 for BD is shifted at most in the tracking direction under the condition that 1/R is less than or equal to 0.012 (1/mm).

The equation (1) below expresses a condition for the red color laser beam to enter the objective lens 14 for BD in the optical system as shown in FIG. 3A at a degree of non-parallelization that is the same as the degree of non-parallelization of the red light entering the objective lens 14 for BD in the optical system having a distance R between the surface of the objective lens 14 for BD and the red light source 18 as shown in FIG. 3B.
|f^{2/}Z|+d=R (1)
Here, f is a focal length of the collimator lens 9 at the wavelength of the red color, Z is a difference between the focal length f and a length of the optical axis of the red color laser beam from the light emission point 4b for DVD to the principal plane S of the collimator lens 9, and d is a distance obtained by subtracting the focal length f from the distance between the principal plane of the collimator lens 9 and the surface of the objective lens 14 for BD.

Then, Z can be obtained by assigning a value such that the above-mentioned 1/R becomes 0.012 (1/mm) to R in the equation (1). When Z is set to be a value less than or equal to the determined value, the degree of non-parallelization of the red color laser beam that enters the objective lens 14 for BD is adjusted so that the comatic aberration is within the tolerance even if the objective lens 14 for BD is shifted at most in the tracking direction.

Furthermore, when information is reproduced or recorded on the CD, the infrared laser beam that enters the objective lens 14 for BD is the diverging non-parallel rays, as described above. If the infrared laser beam enters the objective lens 14 for BD as the parallel rays, a spherical aberration will be generated on the disk recording surface of the CD due to a difference between wavelengths of the infrared laser beam and the blue color laser beam for BD or a difference between the thicknesses of the disk cover layers of the CD disk and the BD. In order to reduce the spherical aberration, the infrared laser beam that enters the objective lens 14 for BD is adjusted to be the diverging non-parallel rays.

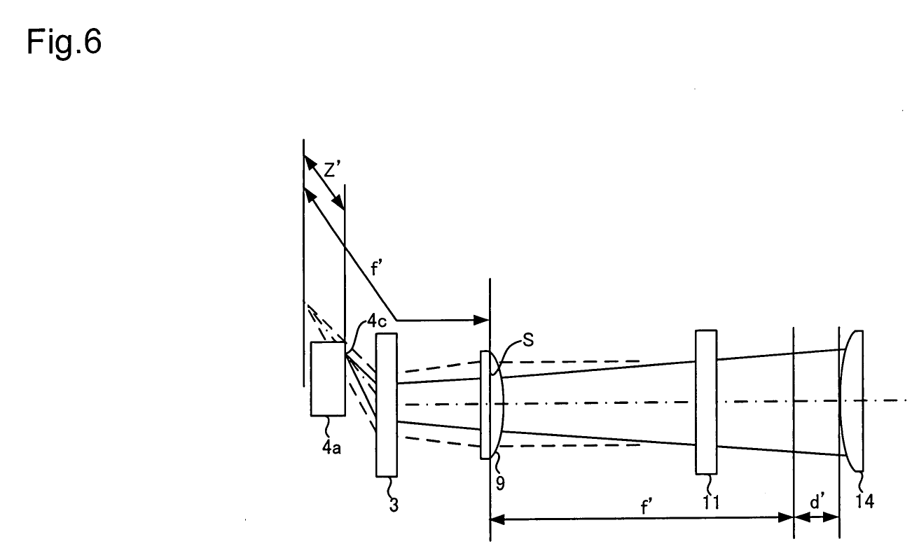

FIG. 6 shows an optical system from the light emission point 4c for CD of the monolithic laser diode chip 4a to the objective lens 14 for BD. However, optical components other than the monolithic laser diode chip 4a, the hologram element 3, the collimator lens 9, the wavelength selective aperture 11 and the objective lens 14 for BD are omitted. As shown in FIG. 6, a length of the optical axis of the infrared laser beam from the light emission point 4c for CD to the principal plane S of the collimator lens 9 is set to a value shorter than a length f of the optical axis of the infrared laser beam from a focal point of the infrared laser beam to the principal plane of the collimator lens 9 when the infrared laser beam that is the parallel rays enters the collimator lens 9, goes out from the collimator lens 9, enters the hologram element 3, and is focused by the hologram element 3. Thus, the infrared laser beam emitted from the collimator lens 9 becomes the diverging non-parallel rays, and the infrared laser beam that enters the objective lens 14 for BD becomes the diverging non-parallel rays.

If a degree of non-parallelization of the infrared laser beam that enters the objective lens 14 for BD is set to be a large value, the spherical aberration can be zero substantially. However, if the degree of non-parallelization is set to be an excessively large value, a comatic aberration, which is generated on the recording surface of the disk when the objective lens 14 for BD is shifted in the tracking direction, increases and exceeds a permissible value. If the comatic aberration exceeds the permissible value, a reproduction error or a recording failure may be generated due to a cross talk. In order to avoid this situation, the following countermeasure is adopted in the present invention.

In the same way as described above with reference to FIG. 3B, it is supposed that an infrared light source is disposed at a position away from the surface of the objective lens 14 for BD by a distance R, the objective lens 14 for BD is shifted in the tracking direction so that the optical axis of the objective lens 14 for BD is shifted from the optical axis of the infrared light emitted from the infrared light source, and the wavelength selective aperture 11 disposed between the infrared light source and the objective lens 14 for BD is also shifted together with the objective lens 14 for BD as one unit. Under this situation, a simulation of the comatic aberration that is generated on the recording surface of the disk was performed.

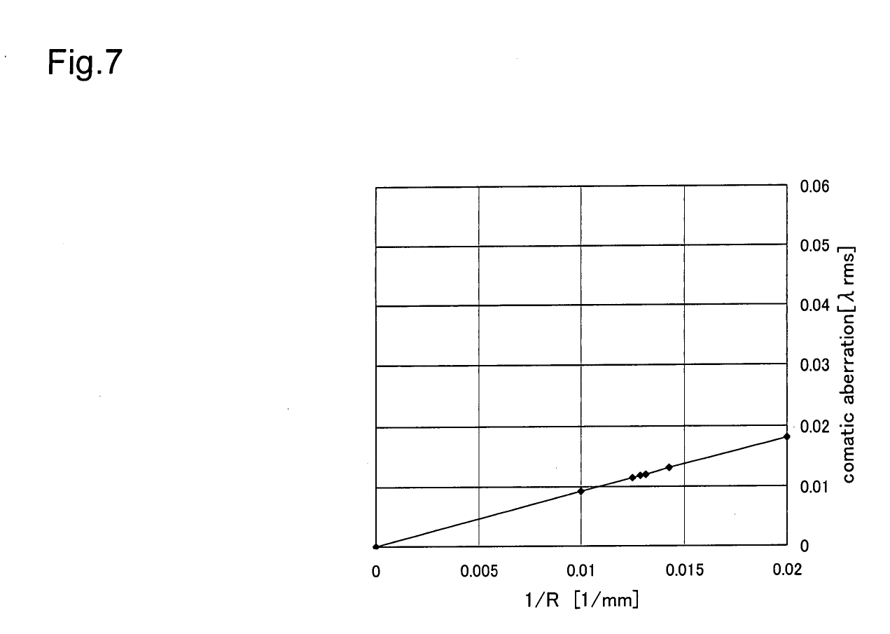

FIG. 7 shows a simulation result of the comatic aberration that is generated when the objective lens 14 for BD is shifted at most in the tracking direction while changing the distance R. In a graph of FIG. 7, the horizontal axis is 1/R. When 1/R is zero, i.e., R is infinite, light entering the objective lens 14 for BD becomes parallel rays, and the comatic aberration is not generated (becomes zero). The more the 11/R increases from zero, the degree of non-parallelization of the light entering the objective lens 14 for BD increases, resulting in an increase of the comatic aberration. As described above, the maximum value of 1/R such that the comatic aberration is within the tolerance even if the objective lens 14 for BD is shifted at most in the tracking direction when information is reproduced or recorded on the DVD is 0.012 (1/mm). In this case, the comatic aberration in FIG. 7 is 0.012 (λrms).

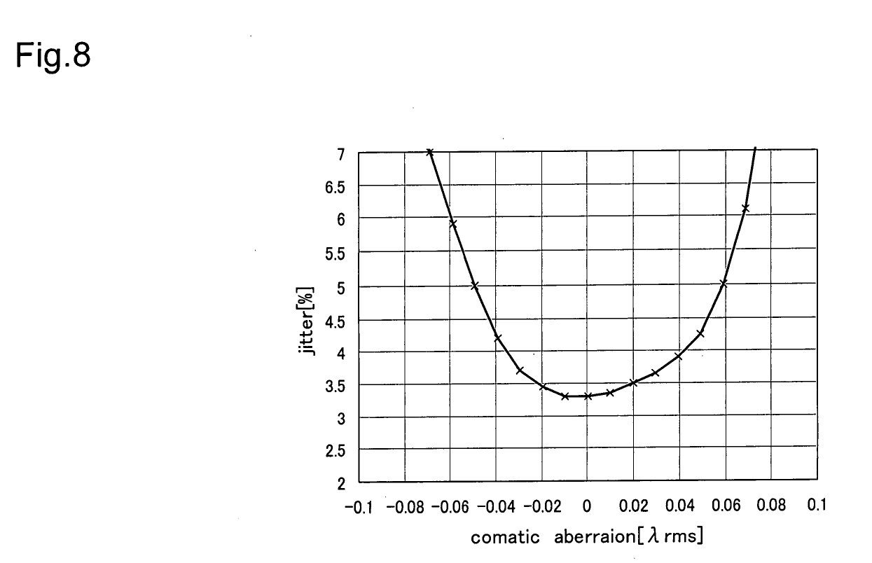

FIG. 8 shows an example of a relationship between the comatic aberration generated on a recording surface of the CD and a jitter of a reproduction signal measured at that time. In this example, the jitter becomes the minimum value 3.4% when the comatic aberration is zero. If the permissible value (the maximum value) of the jitter is 4.4% that is 1% larger than the minimum value 3.4%, the tolerance of the comatic aberration becomes −0.04 (λrms) to 0.05 (λrms) as shown in FIG. 8. Therefore, if 1/R is 0.012 (1/mm) as described above, the comatic aberration is within the tolerance even if the objective lens 14 for BD is shifted at most in the tracking direction.

The equation (2) below expresses a condition for the infrared laser beam to enter the objective lens 14 for BD in the optical system as shown in FIG. 6 at a degree of non-parallelization that is the same as the degree of non-parallelization of the infrared light entering the objective lens 14 for BD in the optical system having a distance R between the surface of the objective lens 14 for BD and the infrared light source.
|f²/Z′|+d′=R (2)

Here, f′ is a length of the optical axis of the infrared laser beam from a focal position of the infrared laser beam to the principal plane of the collimator lens 9 when the infrared laser beam that is parallel rays enters the collimator lens 9, goes out from the collimator lens 9, enters the hologram element 3, and is focused by the hologram element 3. Further, Z′ is a difference between the length f′ and a length of the optical axis of the infrared laser beam from the light emission point 4c for CD to the principal plane S of the collimator lens 9, and d′ is a distance obtained by subtracting the length f′ from the distance between the principal plane of the collimator lens 9 and the surface of the objective lens 14 for BD.

Since the value of Z is set as described above and a position of the light emission point 4b for DVD is determined, the position of the light emission point 4c for CD is determined at the same time. Therefore, if the hologram element is designed and arranged so that a value of R in the equation (2) satisfies the expression 1/R=0.012 (1/mm) as described above, the degree of non-parallelization of the infrared laser beam entering the objective lens 14 for BD is adjusted so that the comatic aberration is within the tolerance even if the objective lens 14 for BD is shifted at most in the tracking direction.

As described above, the degree of non-parallelization of the laser beam entering the objective lens 14 for BD when information is reproduced or recorded on the DVD and the CD is set considering the comatic aberration. However, in this state, the spherical aberration remains. Therefore, in the present invention, the liquid crystal element 12 (see FIG. 1) is used for correcting the spherical aberration. The liquid crystal element 12 includes a liquid crystal material and electrodes that sandwich the liquid crystal material. A zone plate pattern is formed on at least one of the electrodes. Then, the electrode is supplied with a drive voltage from the liquid crystal driver, so that the wavefront of the laser beam that passes through the liquid crystal element 12 is changed and the spherical aberration is corrected. Concerning the voltage that is applied to the electrode, a voltage pattern such that the jitter of the reproduction signal becomes the minimum is detected for each of the DVD and the CD in a stage of manufacturing the disk device, and the detected voltage pattern is stored in a memory of the disk device. When information is reproduced or recorded on the DVD or the CD, the voltage pattern is read out from the memory and is applied to the electrode. Furthermore, it is possible to measure a jitter of the reproduction signal while changing the voltage pattern that is applied to the electrode every time when the disk is exchanged, so that the voltage pattern such that the jitter of the reproduction signal becomes the minimum can be determined. The determined voltage pattern may be used for applying the voltage to the electrode for reproducing or recording information so as to respond individual differences of disks.

What is claimed is:

1. An optical pickup, comprising:
a first light source for a first disk;
a second light source for a second disk that has a lower density than the first disk;
a collimator lens; and
an objective lens for the first disk, wherein
an optical axis of a first light beam emitted from the first light source overlaps an optical axis of the collimator lens,
a length of the optical axis of the first light beam from the first light source to a principal plane of the collimator lens is the same as a focal length of the collimator lens at a wavelength of the first light beam, so that the first light beam going out from the collimator lens and entering the objective lens for the first disk becomes parallel rays,
an optical axis of a second light beam emitted from the second light source overlaps an optical axis of the collimator lens, and
a length of the optical axis of the second light beam from the second light source to the principal plane of the collimator lens is shorter than the focal length of the collimator lens at the wavelength of the second light beam, so that the second light beam going out from the collimator lens and entering the objective lens for the first disk becomes non-parallel rays.

2. The optical pickup according to claim 1, wherein a degree of non-parallelization of the second light beam entering the objective lens for the first disk is adjusted so that a comatic aberration that is generated on a recording surface of the second disk becomes a value within a tolerance when the objective lens for the first disk is shifted at most in the tracking direction.

3. The optical pickup according to claim 2, further comprising a liquid crystal element for correcting a spherical aberration that is generated on the recording surface of the second disk.

4. The optical pickup according to claim 1, further comprising
a monolithic laser diode chip having the second light source and a third light source for a third disk that has lower density than the first disk, and
a hologram element disposed on an optical path from the monolithic laser diode chip to the collimator lens, wherein
a third light beam emitted from the third light source enters the hologram element,
an optical axis of the third light beam going out from the hologram element overlaps the optical axis of the second light beam, and
a length of the optical axis of the third light beam from the third light source to the principal plane of the collimator lens is shorter than a length of an optical axis from the position where light going out from the hologram element is focused to the principal plane of the collimator lens when parallel rays having the same wavelength as the third light beam enter the collimator lens, so that the third light beam going out from the collimator lens and entering the objective lens for the first disk becomes the non-parallel rays.

5. The optical pickup according to claim 4, wherein a degree of non-parallelization of the third light beam entering the objective lens for the first disk is adjusted so that a comatic aberration that is generated on a recording surface of the third disk becomes a value within a tolerance when the objective lens for the first disk is shifted at most in the tracking direction.

6. The optical pickup according to claim 5, further comprising a liquid crystal element for correcting a spherical aberration that is generated on the recording surface of the third disk.

7. The optical pickup according to claim 2, further comprising
a monolithic laser diode chip having the second light source and a third light source for a third disk that has lower density than the first disk, and
a hologram element disposed on an optical path from the monolithic laser diode chip to the collimator lens, wherein
a third light beam emitted from the third light source enters the hologram element,
an optical axis of the third light beam going out from the hologram element overlaps the optical axis of the second light beam, and
a length of the optical axis of the third light beam from the third light source to the principal plane of the collimator lens is shorter than a length of an optical axis from the position where light going out from the hologram element is focused to the principal plane of the collimator lens when parallel rays having the same wavelength as the third light beam enter the collimator lens, so that the third light beam going out from the collimator lens and entering the objective lens for the first disk becomes the non-parallel rays.

8. The optical pickup according to claim 7, wherein a degree of non-parallelization of the third light beam entering the objective lens for the first disk is adjusted so that a comatic aberration that is generated on a recording surface of the third disk becomes a value within a tolerance when the objective lens for the first disk is shifted at most in the tracking direction.

9. The optical pickup according to claim 8, further comprising a liquid crystal element for correcting a spherical aberration that is generated on the recording surface of the third disk.

10. The optical pickup according to claim 3, further comprising
a monolithic laser diode chip having the second light source and a third light source for a third disk that has lower density than the first disk, and
a hologram element disposed on an optical path from the monolithic laser diode chip to the collimator lens, wherein
a third light beam emitted from the third light source enters the hologram element,
an optical axis of the third light beam going out from the hologram element overlaps the optical axis of the second light beam, and
a length of the optical axis of the third light beam from the third light source to the principal plane of the collimator lens is shorter than a length of an optical axis from the position where light going out from the hologram element is focused to the principal plane of the collimator lens when parallel rays having the same wavelength as the third light beam enter the collimator lens, so that the third light beam going out from the collimator lens and entering the objective lens for the first disk becomes the non-parallel rays.

11. The optical pickup according to claim 10, wherein a degree of non-parallelization of the third light beam entering the objective lens for the first disk is adjusted so that a comatic aberration that is generated on a recording surface of the third disk becomes a value within a tolerance when the objective lens for the first disk is shifted at most in the tracking direction.

12. The optical pickup according to claim 11, further comprising a liquid crystal element for correcting a spherical aberration that is generated on the recording surface of the third disk.

13. An optical pickup, comprising:
a first light source for a Blu-ray Disc;
a monolithic laser diode chip having a second light source for a DVD and a third light source for a CD;
a collimator lens;
an objective lens for Blu-ray Disc; and
a hologram element disposed on an optical path from the monolithic laser diode chip to the collimator lens, wherein
an optical axis of a first light beam emitted from the first light source overlaps an optical axis of the collimator lens,
a length of the optical axis of the first light beam from the first light source to a principal plane of the collimator lens is the same as a focal length of the collimator lens at a wavelength of the first light beam, so that the first light beam going out from the collimator lens and entering the objective lens for the Blu-ray Disc becomes parallel rays,
an optical axis of a second light beam emitted from the second light source overlaps an optical axis of the collimator lens,
a length of the optical axis of the second light beam from the second light source to the principal plane of the collimator lens is shorter than the focal length of the collimator lens at the wavelength of the second light beam, so that the second light beam going out from the collimator lens and entering the objective lens for the Blu-ray Disc becomes non-parallel rays,
a degree of non-parallelization of the non-parallel rays is adjusted so that a comatic aberration that is generated on a recording surface of the DVD becomes a value within a tolerance when the objective lens for the Blu-ray Disc is shifted at most in the tracking direction,
a third light beam emitted from the third light source enters the hologram element,
an optical axis of the third light beam going out from the hologram element overlaps the optical axis of the second light beam,
a length of the optical axis of the third light beam from the third light source to the principal plane of the collimator lens is shorter than a length of an optical axis from the position where light going out from the hologram element is focused to the principal plane of the collimator lens when parallel rays having the same wavelength as the third light beam enter the collimator lens, so that the third light beam going out from the collimator lens and entering the objective lens for the Blu-ray Disc becomes the non-parallel rays,
a degree of non-parallelization of the non-parallel rays is adjusted so that a comatic aberration that is generated on a recording surface of the CD becomes a value within a tolerance when the objective lens for the Blu-ray Disc is shifted at most in the tracking direction, and
a liquid crystal element for correcting a spherical aberration that is generated on the recording surfaces of the DVD and the CD is provided.
